(19) United States
(12) Patent Application Publication
(10) Pub. No.: US 2004/0117647 A1
(43) Pub. Date: Jun. 17, 2004

(54) Computer digital audio-video data recorder

(75) Inventor: Clinton L. Ballard, Suquamish, WA (US)

Correspondence Address: STEVEN P KODA, KODA LAW OFFICE, 8070 E MILLPLAIN BLVD, No.141, VANCOUVER, WA, 98664, US

(73) Assignee: Acceleration Software International Corporation, Poulsbo, WA

(21) Appl. No.: 10/316,448

(22) Filed: Dec. 11, 2002

(51) Int. Cl. H04L 9/00

(52) U.S. Cl. 713/200

(57) ABSTRACT

A digital audio video recorder captures a stream of audio video (AV) data targeted for output onto a computer display. The content is intercepted from a DVD playback, an internet data stream, an audio disc or another audio, video or audio-video source and routed to a select encoder for compression. Various encoders are available for recording at varying fidelity and speed. The intercepted also is encrypted with a key. The key is specific to the medium to which the captured AV stream is stored. The encryption step prevents the AV content from being distributed, but allows the AV stream to be played back later from the same medium onto which it was captured. The AV stream is compressed and encrypted on a frame by frame or a batch-frame basis.

### BACKGROUND OF THE INVENTION

The present invention is directed to methods and apparatus for capturing video and audio data targeted for display, and more particularly for a method and apparatus for recording a sequence of audio-video frames destined for a computer display.

Video cassette recorders (VCRs) record audio-video content from a television signal or S-video signal storing the content on a video tape having video tracks and audio tracks. A DVD recorder also records audio-video content, but as a digital signal. The audio and video information is stored in protected zones of a DVD disc. Video and audio data is generated for a computer using protocols such as Quicktime or WAV.

### SUMMARY OF INVENTION

A digital audio video recorder captures a stream of audio video (AV) data targeted for output onto a computer display. For a DVD, the manufacturer's encryption of the DVD data is decoded (decrypted) during play back. The data stream then is intercepted from the DVD playback, or from an internet data stream, an audio disc playback or another audio, video or audio-video playback source.

The intercepted data is routed to a select encoder for compression. Various encoders are available for recording at varying fidelity and speed. The intercepted stream (e.g., AV stream) also is encrypted with a key. The key is specific to the medium or network to which the captured AV stream is stored (or to the device for storing the data). The encryption step prevents the AV content from being distributed, but allows the AV stream to be played back later from the same medium onto which it was captured. In one embodiment, the AV stream is compressed and encrypted on a frame by frame basis. In alternative embodiments, the AV stream is compressed and encrypted in batches of frames. Accordingly, the manufacturer's encryption is decoded, but replaced with a compression and encryption scheme to protect against unrestricted copying. As a result, the intercepted data is stored and available for later playback from one of the medium or network to which it is stored, or the device onto which the stream is stored.

In some embodiments an additional copy protection is implemented for a DVD source. A DVD disc includes zone level protection with each zone being encrypted. A verification operation is performed to verify that an authorized zone is being recorded. Accordingly, even if the user has an original DVD disc, the user can only record from zones on the disc where AV data is played back.

### BRIEF DESCRIPTION OF THE DRAWINGS

FIG. 1 is a block diagram of host computer system;

FIG. 2 is block diagram of an apparatus for intercepting a DVD stream;

FIG. 3 is a block diagram of an apparatus for intercepting an internet data stream;

FIG. 4 is a block diagram of a DVD player and a portion of the computer digital audio video data recorder;

FIG. 5 is a block diagram of a remaining portion of the computer audio video data recorder;

FIG. 6 is a flow chart of a method for capturing a video frame;

FIG. 7 is a flow chart of a corresponding method for capturing associated audio data; and

FIG. 8 is a flow chart of a playback method for the captured audio video data.

### DESCRIPTION OF SPECIFIC EMBODIMENTS

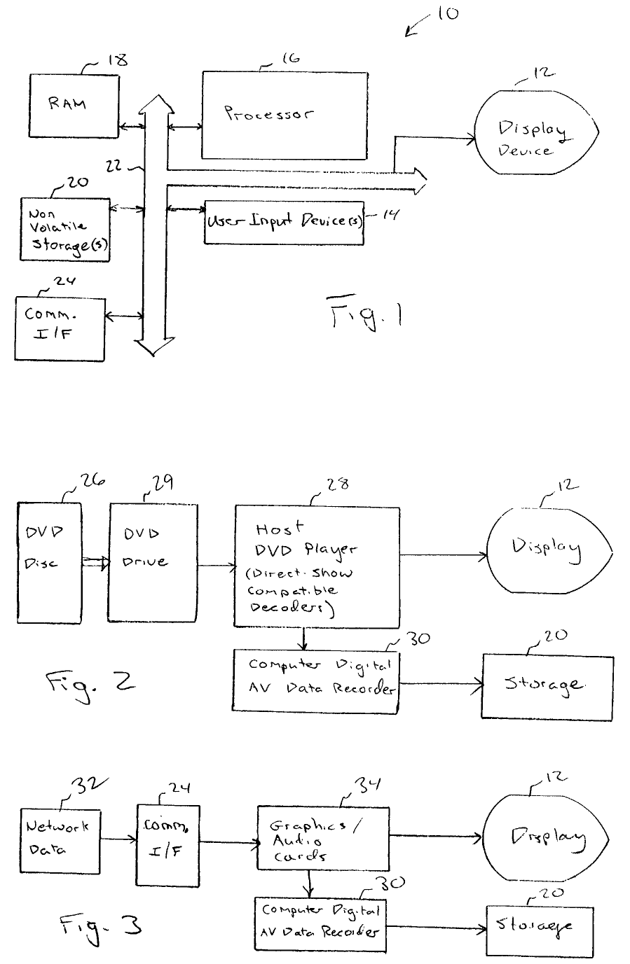

The functions of the present invention preferably are performed by a programmed digital computer of the type well known in the art. Referring to FIG. 1, a host computing system 10 has a display device 12, one or more a user input devices 14, a processor 16, random access memory (RAM) 18, and one or more non-volatile storage devices 20 interconnected by a bus or other wired or non-wired interface 22. Exemplary display devices 12 include a CRT monitor, an LCD panel, a television monitor, a plasma display and a projection display device. Exemplary user input devices include a keyboard, a pointing/clicking device, and a touch screen. The storage devices 20 are either fixed storage devices or transportable storage devices. The transportable storage devices read transportable storage media. An exemplary fixed storage device is a hard disk drive. Exemplary transportable storage devices include a DVD drive, a CD-ROM drive, a recordable CD drive, a combined DVD/CD drive, a floppy disk drive, a Zip drive, a Bernoulli drive, and other magnetic, optical or other storage media drives. In some embodiments the computing system 10 also includes a communication or network interface 24 (e.g., modem; Ethernet; firewire; USB; Appletalk).

The various components exchange data and commands through one or more of the bus or other data interfaces 22. The computing system 10 may be any of the types well known in the art, such as a mainframe computer, minicomputer, or microcomputer. The computing system 10 may even be configured as a workstation, personal computer, network server, laptop computer, hand-held computer, personal digital assistant, or a reduced-feature network terminal device. For a general purpose computer system information is received by entry at user input devices 14, including a keyboard and pointing/clicking device, and through a network interface or another input device or input port.

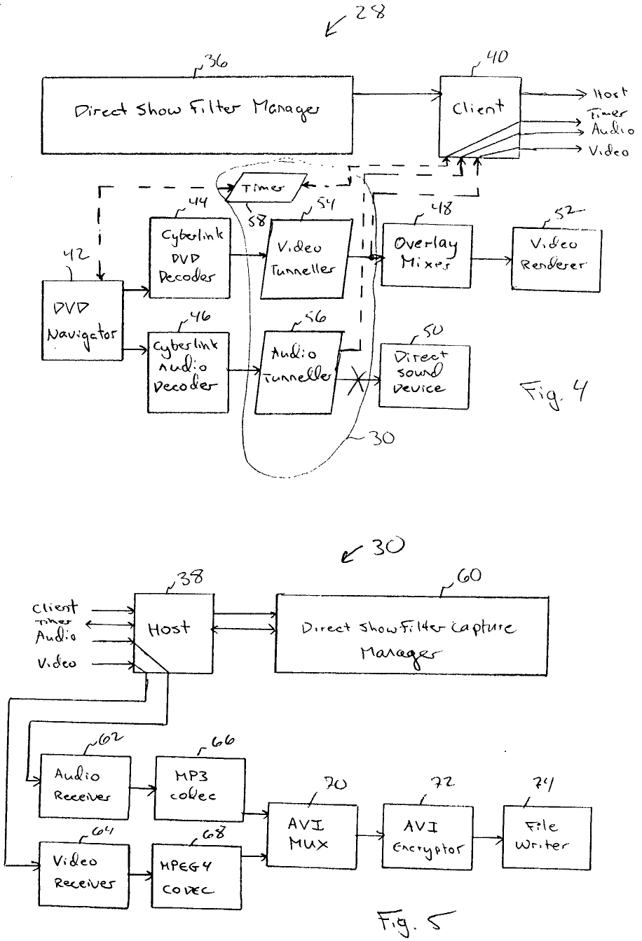

Although, DVD content, internet content, audio disc content and other audio and/or video data content is recorded in varying embodiments, an exemplary embodiment is described regarding FIG. 2 for capturing DVD audio-video content. An exemplary embodiment for capturing network (e.g., intent) content is described regarding FIG. 3. DVD audio-video (AV) content is captured from a DVD disc 26 without decrypting disc content, while using a third-party DVD player 28, such as PowerDVD, WinDVD or any other DVD player with DirectShow-compatible decoders. A DVD disc 26 is inserted into a DVD drive 29. The host DVD player 28 plays back the content directing the audio video output to the display device 12. The computer digital AV data recorder 30 intercepts the unencrypted audio-video data and stores the data on a non-volatile storage medium 20, such as a compact disk, floppy disk, tape, zip disk, or other magnetic or optical storage media. Referring to FIG. 3, AV network data 32 (e.g., internet data) streaming onto a host computing system 10 over a communication interface 24 (a network interface, such as a telephone modem, cable modem, satellite modem, LAN interface or WAN interface) is directed to a display device 12 through a graphics/audio card(s) 34. The computer digital AV data recorder 30 intercepts the streaming data and stores the data on a non-volatile storage medium 20, such as the compact disk, floppy disk, tape, zip disk, or other magnetic or optical storage media.

FIG. 4 shows the host DVD player 28 with added computer digital AV data recorder 30 modules. The DVD player 28 includes a direct show filter manager 36 which interfaces to the host 38 through a client interface 40. A DVD navigator module 42 controls playback of the DVD disc 26 (see FIGS. 2 and 4). A cyberlink DVD decoder 44 decodes the video data, directing the data to an overlay mixer 48, which in turn directs the video data to a video renderer 52. The video renderer 52 directs the data to the display device 12 (see FIG. 2). A cyberlink audio decoder 46 decodes the audio data, directing the audio data to a direct sound device 50 for audio output. The DVD navigator 42 keeps the video and audio feeds synchronized. To provide AV data capture, a video tunneller module 54, audio tunneller module 56 and timer 58 are included. These modules 54, 56, 58 are part of the computer digital AV data recorder 30.

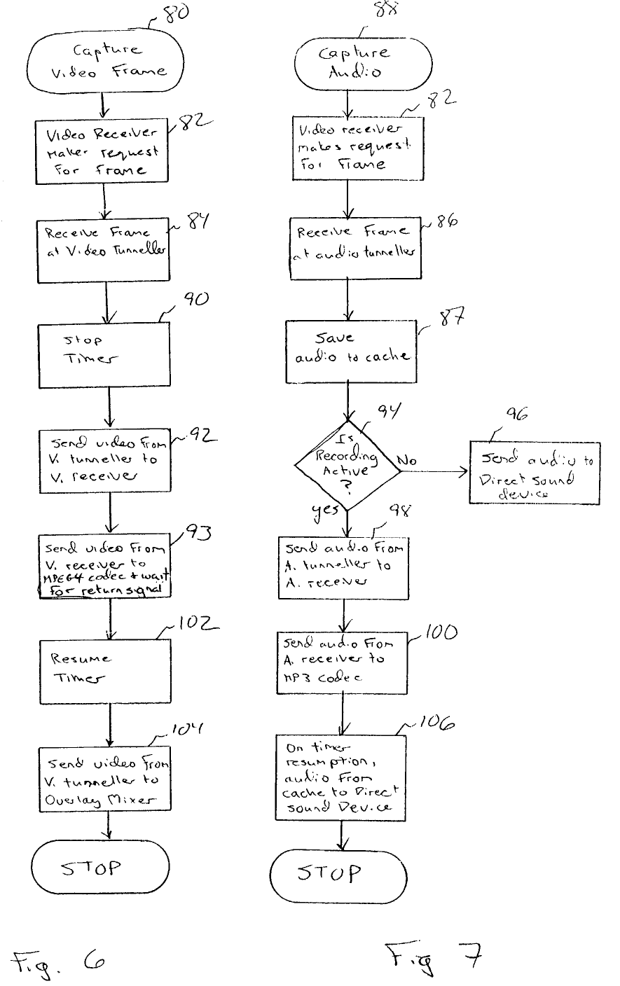

Referring to FIG. 5, the remaining modules of the computer digital AV data recorder 30 include a host interface 38 and a direct show filter capture manager 60. Also included is an audio receiver 62, a video receiver 64, an MP3 codec 66, an MPEG4 codec 68, an audio visual interface (AVI) multiplexor 70, an AVI encryptor 72 and a file writer module 74. Audio data is received at the host interface 38 and routed to the audio receiver 62 and on to the MP3 codec 66. The video data also is received at the host interface 38 and routed to the video receiver 64 and on to the MPEG4 codec 68. The outputs of the MP3 codec 66 and MPEG4 codec 68 form the audio video inputs to the AVI mux 70. The AVI mux 70 output is encrypted by AVI encryptor 72 and stored as a file by file writer 74.

The timer module 58 (see FIG. 4) is coupled to all modules involved in filtering operations (e.g., tunnellers, receivers, and codecs) to obtain information about real time display.

In operation an operator enters a command to record DVD content. Prior to recording, the DVD zone is tested to determine if copying is permitted from that zone. Each DVD player manages what zone it is allowed to work in. Specifically, some DVD players adapt to the type of DVD that is being used, while others DVD players have a limited zone capability set by the manufacturer. Thus, some DVD players only have access to a limited zone subset. DVD data may be captured only from a zone that the DVD player is adapted to handle or only from zones that a DVD player is preprogrammed (by the DVD player manufacturer) to handle. DVD data may be captured only from zones to which the host playback device has access. The computer digital AV recorder 30 communicates with the DVD player decoders 44, 46 to determine whether the DVD player is streaming AV data from the correct zone. The digital AV recorder 30 uses the playback limitations and ability of the 3^{rd} party DVD player 28. The DVD decoders 44, 46 decrypt the audio video data. The decrypted DVD audio video data is then captured and recorded onto a storage medium. When storing the captured data, a code is added to each data sample being stored. In one embodiment, the code identifies the media, device or network on which the sample is being stored. For example, a media, device or network serial number may be used as the code. In one embodiment all AV samples after the 1024^{th} byte are XOR'ed with the code. In addition, the first 12 bytes of the AVI header are changed from RIFFxxxxAVI to CDAVRxxxxAVI (CDAVR=computer digital audio video recorder). During a later playback, the computer media player (or any other diract show compatible manager) loads the computer digiral audio video recorder's decoder module to playback the captured, stored content.

During playback, the code is compared to the serial number (or other standardized identifying data used to form the code). If the code is invalid, then playback is not allowed. The audio video content may be recorded and played back from any type of medium (e.g., tape, floppy, CD), but copying of the captured data is ineffective. More importantly, such storage specific code prevents the captured data from being mass distributed. In effect, the AV content is captured onto a given storage medium (or network), and may be played back later only from that storage medium (or network). This demonstrates the computer digital AV data recorder purpose being to time-shift data content (e.g., streaming data captured off the internet), or to back up data content (DVD, CD) , while preventing mass copying. In a sense this is a compromise solution to alleviate ‘pirating’ concerns of copyright holders.

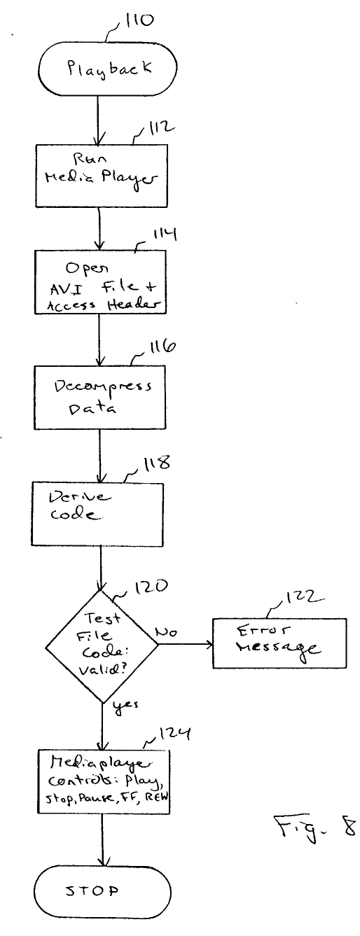

In a preferred embodiment AV content is captured one frame at a time. In alternative embodiments, the AV content is captured in batches of frames. Referring to FIGS. 6 and 7 the steps for capturing video content and audio content for a given frame are shown. At step 82 of a video frame capture operation 80, the video receiver 64 indicates a readiness to receive a video frame. The direct show filter capture manager 60 then signals the direct show manager 36 to playback a frame. At step 84, the video tunneller 54 receives the video frame. Concurrently, at step 86 of a capture audio operation 88, the audio data corresponding to the video frame is received at the audio tunneller 56. At step 87, the audio data is stored in cache (random access memory 18—see FIG. 1). At step 94, testing is performed to determine whether recording is active. If not, active than at step 96 the audio data is sent to the direct sound device 50 for audio output.

At step 90 the timer 58 is stopped. This prevents the DVD navigator 42 from forwarding the next frame until the timer 58 is resumed. At step 92 the video data is forwarded from the video tunneller 54 through the client interface 40 and host interface 38 to the video receiver 64. The video receiver 64 forwards the video data to an MPEG4 codec 68 at step 93, then waits for a return signal. Concurrently, when recording is active, at step 98 of the audio capture operation 88, audio data is sent from the audio tunneller 56 through the client interface 40 and host interface 38 to the audio receiver 62. The audio receiver 62 forwards the audio data to an MP3 codec 66 at step 100. The audio data from the MP3 codec 66 and the video data from the MPEG4 codec 68 are sent to the audio video interface 70, and a signal is sent from the MPEG4 codec 68 to the video receiver 64 indicating that the video data has been transferred. The direct show filter capture manager then restarts the timer 58 at step 102. On timer resumption, at step 104 of the capture video frame operation 80, the video frame data is sent from the video tunneller 54 to the overlay mixer 48, then to the video renderer 52 for video output on the display device 12. Also on timer resumption, at step 106 of the capture audio operation 88, the audio data is output from cache to the direct sound device 50 for audio output.

When the MPEG4 codec 68 sends the signal to the video receiver 64, the receiver 64 sends a signal to the direct show filter capture manager 60 indicating that it is ready for the next video frame. The direct show filter capture manager 60 in turn resumes the timer 58, and thereafter, sends a signal to the direct show filter manager 36, to resume playback. The next video frame then is played back and captured in similar fashion.

Referring again to FIG. 5, the AVI mux 70 forwards the AV data to the AVI encryptor 72 where the media, device or network specific code is attached to the unencrypted video data and audio data. The encryptor 72 also compresses the data. The compressed, coded data then is written into a file by the file writer 74. For a windows-based host computer, the compressed, coded data is written to an AVI file.

The AVI file may later be retrieved and accessed for playback. Referring to FIG. 8, a playback method 110 includes at step 112 running the media player or other direct-show-filter compatible player. At step 114 the operator identifies the file to be played back. The header information is accessed indicating the decoder modules to be used. Specifically the CDAVR code is identified, indicating that the computer digital AV recorder 30 decoding modules are to be used. At step 118, a portion of the file is decompressed. At step 120, a code is derived for either the storage media, storage device or network on which the played back file is stored depending on the embodiment. In different embodiments, one of such sources is used to form the stored code. Thus, the specific source of the code is known and used to derive a code at this step. For example, if the file was formed using a network code, then at step 118 the network serial number is retrieved and used to derive a code. At step 120, the derived code is compared to the code portion of the stored AV data frame. If the retrieved code portion corresponds to the derived code, then playback is allowed. If the codes do not correspond, then an error message is displayed at step 122 indicating that playback is not permitted (or that the file is an unauthorized copy), or the like. If playback is allowed, then at step 124 the media controller plays back the AV data allowing the user access to the media player controls (e.g., play, stop, pause, fast forward, rewind). In varying embodiments, the code testing is performed at the beginning of the playback or at each frame of the playback. Also, in varying embodiments, the AV data is streamed through the media player being decompressed and played back, rather than having the file completely decompressed before commencing playback.

When playback is authorized, the media player forwards each decompressed and decoded frame to the appropriate source for video display and audio output. For example, for a DVD file, the decompressed, decoded video data is forwarded to the overlay mixer 48 (see FIG. 4), while the audio data is forwarded to the direct sound device 50.

Pseudo-code for an exemplary embodiment:

External interface of DVCR

All logic is incapsulated in Navigator com-object.

Description

\Include\DvNavigator.h

Example that shows how to use it—project DVCR, it does not include any DirectShow headers, only DvNavigator.h. Other headers included into DVCR are only helpers.

Application that will use DVCR's engine performs:

1. call DvGetNavigator to obtain pointer to Navigator by extern “C” DVNAVIGATOR_API HRESULT DvGetNavigator(IDVCRNavigator **_ppvNavi);

2. initialize if by calling IDVCRNavigator->Init and pass IDVCRCallback pointer to get notifications from Navigator about UI.

Application calls IDVCRNavigator->Release( ) for correct uninitialization of Navigator object.

Reference

Navigator supports the following UI commands (can disable/enable/check/uncheck):

Commands

enum EGuiCommand

{

GC_Stop = 0,
GC_Play,
GC_Pause,
GC_FF,
GC_Rew,
GC_NextChapter, // going to the next chapter
GC_PreyChapter, // going to the previous chapter
GC_Menu, // go to root menu (not possible at any moment, only sometime)
GC_TitleMenu, //to to title menu
GC_SetPos, // going to slider position
GC_Rec, // recording the AVI
GC_GetBitmap, // saving bitmaps
GC_GetOneBitmap, // it is separate state because no action
// will be made with the DVD graph while saving 1 bitmap
GC_Settings, // show “settings” dialog
CC_CloseFile, // close last captured file
GC_DelayedRecord, //toggle flag “start recording when title begins”

};
Modes
-----
Navigator can be in following modes:
enum EGuiMode
{

GM_Undefined = 0, // in this state navigator is if DVD graph cannot build
GM_Stop, // stopped
GM_Play, //playing
GM_Pause, // paused
GM_FF, // fast forwarding
GM_Rew, // rewind
GM_SetPos, // seeking position
GM_Rec, // recording the movie
GM_GetBitmap, // saving the bitmaps

};
Navigator manipulations
-----------------------
This object is used by user application for any operations
with DVD. It incapculates all DVD commands and abstracts from DVD
decoder and hardware particularities.
When working with slider, Navigator always returns total time and
position in special units. For simplicity these units are frames
amount assuming that now is 30fps (DVD can be different by FPS):
nTime = (((HH*60) + MM)*60 + SS) * 30 + FPS
//
// Navigator object interface
//
interface _declspec(uuid(“{36d39eb0-dd75-11ce-bf0e-df1812334452}”))
IDVCRNavigator;
interface IDVCRNavigator : public IUnknown
{

//
// Initialization
//
// _pCallback - pointer to callback interface
// _hParentWnd - window inside that will be out the DVD content
STDMETHOD( Init ) (IN IDVCR Callback * _pCallback, IN HWND _hParentWnd )

PURE;

| // Shutdown the Nabigator | |
|---|---|
| STDMETHOD( Shutdown ) (void ) PURE; | |
| // | |
| // Check DVCR's compatibility | |
| // | |
| // dwCode - can be one of: | |
| // | CMPB_OK - all os ok |
| // | CMPB_EXIT - DVCR will not work at all |
| // | CMPB_WARNING - DVCR will work, but many be unstable |

// pszBuf - buffer with text message
// dwMaxChar - size of buffer pszBuf
STDMETHOD( CheckCompatability ) (OUT DWORD* dwCode, OUT LPTSTR

pszBuf, IN DWORD dwMaxChar ) PURE;

//
// Windows management
//
// Set window style
STDMETHOD( SetWindowStyle ) ( DWORD _dwWindowStyle, DWORD

_dwWindowStyleEx ) PURE; // sets parent window for Video Render

// Switch to full screen
STDMETHOD( SwitchFullScreen )( BOOL _bFull ) PURE;
// returns S_OK - full screen mode, S_FALSE - window mode
STDMETHOD( IsFullScreen ) ( void ) PURE;
// Show modal settings dialog
STDMETHOD( ShowSettings )( HWND _hParent ) PURE;
// Show non-modal extended statistic window
STDMETHOD( ShowStatistics )( HWND _hParent, BOOL _bShow ) PURE;
// Show modal diagnostic dialog
STDMETHOD( ShowDiagnoseDlg )( HWND _hParent ) PURE;
//
// Audio volume
//
// Show/hide volume control
STDMETHOD( ShowVolumeControl )( HWND _hParent, BOOL _bShow ) PURE;
// Ajust the sound
STDMETHOD( SetAudioVolume )( int nVolume ) PURE;
STDMETHOD( GetAudioVolume )( int* pnVolume ) PURE;
//
// Video quality
//
// Quality is number between 1 and 100.
// 1 mean low processor load (about 50%) and minimal lost samples
// 100 mean 100% processor load, but some samples may lost
// Set video quality
// nQuality == −1 mean default value
STDMETHOD( SetVideoQuality )( int nQuality ) PURE;
// Get current quality
STDMETHOD( GetVideoQuality )( int* pnQuality ) PURE;
//
// Navigation on DVD disc
//
STDMETHOD( Play )( ) PURE;
STDMETHOD( Pause )( ) PURE;
STDMETHOD( Stop )( ) PURE; // Reset play pointer to begin
// FastForward and Rewind implemented with 8x ratio
STDMETHOD( FF )( ) PURE;
STDMETHOD( Rew )( ) PURE;
// Changing the chapter
STDMETHOD( NextChapter )( ) PURE;
STDMETHOD( PreyChapter )( ) PURE;
// Show the menu
// _nMenuID can be one of the following:

// DVD_MENU_Title
// DVD_MENU_Root

| // DVD_MENU_Subpicture | |
|---|---|
| // DVD_MENU_Audio | |
| // DVD_MENU_Angle | |
| // DVD_MENU_Chapter | |
| STDMETHOD( ShowMenu )( DVD_MENU_ID _nMenuID ) PURE; | |
| // Slider Navigation | |
| // | |
| // Converts current units to string number Returns string with current position | |
| // Format string is filling by | |
| // | wsprintf( _psz, _pszFmt, bHours, bMinutes, bSeconds, bFrames) |

STDMETHOD( FormatTime )( UINT _nTime, LPCTSTR _pszFmt, LPTSTR _psz,

UINT _cb ) PURE;

// Set current position inside the current title
// _nTime - position in units from movie start
STDMETHOD( SetCurrentTitlePosition )( UINT _nTime ) PURE;
// Returns current title, chapter, position
// * _pnTime - position in units from movie start
STDMETHOD( GetPosition )( UINT * _pnTitle, UINT * _pnChapter, UINT*

| | |
|---|---|
| _pnTime ) PURE; | // Get current play position |

// Chapters
//
// Not supported now by DVCR's UI
STDMETHOD( GetChapterCount )( UINT _nTitle, UINT* _pcChapters ) PURE;
//
// Recording
//
// Start record immediately or set “delayed record” flag
//
// Record is possible only in “title” DVD domain
// To start capturing from beginning of next title, application
// must set “delayed record flag” and recording will start
//immediately after starting the title
//
// _bDelayed - TRUE to set “delayed record” flag, FALSE to start immediately
// _hWnd - parent window for “SaveAs” dialog (if user chosen “ask always” in

AVIFilePage)

STDMETHOD( Record )( IN BOOL _bDelayed, IN OPTIONAL HWND _hWnd )

PURE;

// Start saving sequence of bitmaps
// _hWnd - parent window for “SaveAs” dialog (if user chosen “ask always” in

BitmapFilePage)

| STDMETHOD( SaveBitmap )( IN OPTIONAL HWND _hWnd ) PURE; | |
|---|---|
| // Stop recording or saving bitmaps | |
| STDMETHOD( CancelRecording )( void ) PURE; | |
| // Returns S_OK if “delayed record” flag is set, and S_FALSE if not | |
| STDMETHOD( IsDelayedRecord )( void ) PURE; | |
| // Turn off the “delayed record” flag | |
| STDMETHOD( TurnOffDelayedRecord )( void ) PURE; | |
| // | |
| // Captured files management | |
| // | |
| // Closes currently opened AVI file to allow the user see the | |
| // captured movie. | |
| // By default captured file is opened to allow append to it, | |
| // and close it when exiting or by CloseFile call | |
| STDMETHOD( CloseFile )( void ) PURE; | |
| // | |
| // Debug interface - MUST be removed in release | |
| // | |
| // | |
| // _wParam == 0: show/hide debug window with internal state of | |
| // | Navigator object |
| // | _lParam - parent window HWND |
| // | |

// Other values of _wParam is not supported now
STDMETHOD( DebugCmd )( WPARAM _wParam, LPARAM _lParam ) PURE;

};
UI notifications (callback)
---------------------------
Application that uses Navigator engine must advise to Navigator
object with IDVCRCallback interface, passing as parameter to
IDVCRNavigator::Init.

| // | |
|---|---|
| // Callback interface (implemented in sample application “DVCR”) | |
| // | |
| interface _declspec(uuid(“{36d39eb0-dd75-11ce-bf0e-df1812334451}”)) | |
| IDVCRCallback; | |
| interface IDVCRCallback | :public IUnknown |
| { | |

// Called when Navigator state has been changed.
// _lParam is reserved for future use
STDMETHOD( UpdateStatus )( EGuiMode _mode, LPARAM _lParam ) PURE;
// Called to update buttons/menuitems state (enableldisable, check|uncheck)
// flags can be GCS_DISABLED or/and GCS_CHECKED
STDMETHOD( UpdateButton )( EGuiCommand _cmdId, DWORD _dwFlag )

PURE;

// Called when total title time is calculated or changed
// Update scroller and title/chapter indicator
// _nMax is maximal slider position in some units (hh+mm+ss+frames)
STDMETHOD( SetTitleTime )( UINT _nMax ) PURE;
// Called when position (title, chapter, frame number) is changed
// Now title cannot be changed while playing, but...
STDMETHOD( UpdatePosition )( UINT _nTitle, UINT _nChapter UINT _nPos )

PURE;

// Called on dropping frames/samples
// This data is separated from Extended Statistic window as
// critical parameters that user must see always
//
// _statId can be NS_Drop Video or NS_DropAudio
// _lParam is total amount of dropped samples
STDMETHOD( UpdateStatistic )( ENavStat _statId, LPARAM _lParam ) PURE;

};

Many modifications and variations of the present invention are possible in

light of the above teachings. Thus, it is to be understood that, within the scope of the
appended claims, the invention may be practiced otherwise than as described
hereinabove.

What is claimed is:

1. A method for capturing audio data and video data targeted to for multimedia playback, comprising:
prior to rendering the video data for display, intercepting the video data;
compressing the video data;
prior to generating sound from the audio data, intercepting the audio data;
compressing the audio data;
multiplexing the audio data and video data
encoding the multiplexed data with a code, the code derived from one or more of the group of sources including a medium onto which the encoded multiplexed data is to be stored, a device for storing the encoded multiplexed data and a network on which the encoded multiplexed data is to be stored; and
storing the encoded multiplexed data.

2. The method of claim 1, further comprising:
retrieving a header corresponding to the intercepted audio data and video data; and
storing an altered header to change a playback device of the intercepted audio data and video data.

3. The method of claim 1 as applied for capturing audio data and video data played back from a DVD, the DVD having zones, further comprising:
prior to said storing, identifying access privilege to a DVD zone;
determining whether playback access is permitted to said identified DVD zone; and
when playback access is not permitted, precluding said storing.

4. The method of claim 1, further comprising:
intercepting the video data and the audio data on a frame by frame basis;
pausing video mixing and audio output while the intercepted video data and intercepted audio data is received for compression; and
resuming video mixing, and generating audio output, after the intercepted video data and audio data is received.

5. The method of claim 2, in which the code is an applied code, in which the encoded multiplexed data and the altered header are stored in a file, and further comprising:
retrieving the stored file;
deriving a code from said one source of said group of sources;
testing a retrieved portion of the stored file against the derived code to determine whether the encoded multiplexed data in the retrieved portion has said applied code in correspondence to the derived code;
when said applied code is not in correspondence with the derived code, precluding playback of the retrieved portion; and
when said applied code is in correspondence with the derived code, decoding and decompressing the retrieved portion to achieve audio data and video data, said achieved audio data and video data played back to generate synchronized audio output and video display.

6. A method for playing back captured audio data and video data which is stored in a file, comprising:
retrieving at least a portion of the file;
deriving a code from one source of the group of sources including: a storage medium on which the file is stored, a storage device which accesses the stored file, and a network on which the file is stored;
testing the portion of the stored file against the derived code to determine whether the captured audio data and video data stored in said portion is encoded with an applied code which corresponds to the derived code;
when said applied code is not in correspondence with the derived code, precluding playback of the retrieved portion; and
when said applied code is in correspondence with the derived code, decoding and decompressing the retrieved portion to achieve audio data and video data, said achieved audio data and video data played back to generate synchronized audio output and video display.

7. An apparatus for capturing audio data and video data targeted to for multimedia playback, comprising:
means for intercepting the video data prior to rendering the video data for display;
means for compressing the video data;
means for intercepting the audio data prior to generating sound from the audio data;
means for compressing the audio data;
means for multiplexing the audio data and video data
means for encoding the multiplexed data with a code, the code derived from one or more of the group of sources including a medium onto which the encoded multiplexed data is to be stored, a device for storing the encoded multiplexed data and a network on which the encoded multiplexed data is to be stored; and
means for storing the encoded multiplexed data.

8. The apparatus of claim 7, further comprising:
means for retrieving a header corresponding to the intercepted audio data and video data; and
means for storing an altered header to change a playback device of the intercepted audio data and video data.

9. The apparatus of claim 7 as applied for capturing audio data and video data played back from a DVD, the DVD having zones, further comprising:
means for identifying access privilege to a DVD zone;
means for determining whether a copy restriction applies to said identified DVD zone; and
means for precluding said storing when copy restriction applies.

10. The apparatus of claim 7, further comprising:
means for intercepting the video data and the audio data on a frame by frame basis;
means for pausing video mixing and audio output while the intercepted video data and intercepted audio data is received for compression; and
means for resuming video mixing, and generating audio output, after the intercepted video data and audio data is received.

11. The apparatus of claim 8, in which the code is an applied code, in which the encoded multiplexed data and the altered header are stored in a file, and further comprising:
means for retrieving the stored file;
means for deriving a code from said one source of said group of sources;
means for testing a retrieved portion of the stored file against the derived code to determine whether the encoded multiplexed data in the retrieved portion has said applied code in correspondence to the derived code;
means for precluding playback of the retrieved portion when said applied code is not in correspondence with the derived code;
means for decoding and decompressing the retrieved portion to achieve audio data and video data when said applied code is in correspondence with the derived code; and
means for playing back said achieved audio data and video data to generate synchronized audio output and video display.

12. An apparatus for playing back captured audio data and video data which is stored in a file, comprising:
means for retrieving at least a portion of the file;
means for deriving a code from one source of the group of sources including: a storage medium on which the file is stored, a storage device which accesses the stored file, and a network on which the file is stored;
means for testing the portion of the stored file against the derived code to determine whether the captured audio data and video data stored in said portion is encoded with an applied code which corresponds to the derived code;
means for precluding playback of the retrieved portion when said applied code is not in correspondence with the derived code; and
means for decoding and decompressing the retrieved portion to achieve audio data and video data when said applied code is in correspondence with the derived code, said achieved audio data and video data played back to generate synchronized audio output and video display.
